(19) United States
(12) Patent Application Publication
(10) Pub. No.: US 2005/0022680 A1
(43) Pub. Date: Feb. 3, 2005

(54) Marking device for numbering by deformation

(76) Inventors: Fernand Ferroud Plattet, Saint Julien En Genevois (FR); Andre Bouchet, Veyrier Du Lac (FR)

Correspondence Address: Thomas E. Kocovsky, Jr.;FAY, SHARPE, FAGAN, MINNICH & McKEE, LLP, Seventh Floor, 1100 Superior Avenue, Cleveland, OH, 44114-2518, US

(21) Appl. No.: 10/893,398

(22) Filed: Jul. 16, 2004

(30) Foreign Application Priority Data
Jul. 18, 2003 (FR) FR 03 08886
Mar. 31, 2004 (FR) FR 04 03357

(51) Int. Cl. B41F 19/02

(52) U.S. Cl. 101/3.1

(57) ABSTRACT

An embossing head (2) is mounted on an embossing device (1) for movement between an inactive position and a position in which it is pressed against a sheet of metal supported on an anvil (5) to emboss an identification or serial number. The embossing head includes a series of serrated rollers (6a, 6b, 6c, 6d, 6e, 6f) which are rotatably mounted on a transverse axle (7). The rollers are stacked immediately adjacent each other without intervening space. A one piece operating pawl (13) includes a series of staged teeth (29a, 29b, 29c, 29d, 29e, 29f) descending in height from a first to a last of the teeth. The pawl further includes a side projection (30) which lifts the teeth over numbers on the rollers to limit wear.

### BACKGROUND OF THE INVENTION

The present invention concerns an embossing head for deforming material.

The embossing head also called the “Numberer” is designed more particularly to emboss metallic objects such as sheet metal, and for example the body metal of a car, airplane, or an electric appliance that requires identification. Of course, the Numberer of the invention is not solely designed to mark sheet metal, but all types of products for which marking during processing is necessary, indeed obligatory.

There already exist embossing heads, but they are mechanisms of extreme complexity with very little reliability and which is used in many industrial environments, like for example welding projects which often necessitate stopping the machine which is detrimental to the economic plan.

The present invention proposes a new embossing head, insensitive to wear and tear, thanks to its compact and robust design.

### SUMMARY OF THE INVENTION

Also, according to the invention, the embossing head is designed especially for marking metal objects like sheet metal, for example the body metal of a car, airplane, or an electric appliance that requires an identification, which is a type including a succession of rotating serrated wheels on a transverse axis. It is characterized by stacking the rollers next to each other on the pivot axis without space between, that is between their adjacent respective sides, and including an operating pawl is cast solid in one piece.

According to a complimentary characteristic, the embossing head includes an operating ensemble including a pawl and finger of actuation.

According to another characteristic, the operating pawl is cast solid in one piece and includes at the end of its arm, a part that curves towards the serrated rollers, succession of staged teeth. The height of the teeth descends from first, being the tallest, to last. It includes, in addition, a side projection intended to cooperate with patterns in the side hollows on the diametrical face of the first serrated roller.

Let us note that each of the serrated rollers includes an angular system of indexing. That is the position of rotation, constituted by a ball which is urged by a compressing spring into a corresponding hole in the axis of rotation which, in addition, is blocked in rotation.

Let us add that according to the preferred mode of execution, the whole control assembly is urged to an inactive position (that is according to which the pawl is not in contact with the serrated rollers,) by an extension spring, while the serrated marking rollers are rotatably mounted on a transverse axis carried by two lateral walls that support the serrated rollers.

The invention also relates to a marking device equipped with the embossing head according to the invention which is carried by a pivoting lever of a pressing device which includes, in addition, an anvil on which the steel sheet is disposed to be marked.

Other characteristics and advantages of the invention will emerge from description which will follow from the annexed drawings which were only given as nonrestrictive examples.

### BRIEF DESCRIPTION OF THE DRAWINGS

FIGS. 1 and 2 are perspective views of the whole embossing unit with the embossing head of the invention, in its two positions;

FIG. 1 is a view of the inactive position;

FIG. 2 is a view of the active position;

FIG. 3 is a perspective view of the embossing head;

FIG. 4 is an expanded perspective view of the embossing head;

FIG. 5 is a partially assembled expanded view of the embossing head;

FIG. 6 is a perspective view of the stacking of the serrated rollers;

FIG. 7 is a detailed view of the stacking of the serrated rollers together with the pivot assembly to change the markings;

FIG. 8 is a detailed perspective view, the same as FIG. 7, but with the deletion of the side face of the whole pivot assembly;

FIG. 9 is a view from below the operating pawl; and,

FIG. 10 is a detailed sectional view at the level of a marking element.

### DETAILED DESCRIPTION OF THE PREFERRED EMBODIMENT

The marking device carrying the general reference 1 includes an embossing head 2 carried by a pivoting lever 3 of a pressing device 4 which includes, in addition, an anvil 5 on which a metal sheet is disposed to be marked.

The pressing device 4 is the type, for example, of that described in the French patent application published under the Nos. FR 2 754 484 and FR 2 770 167.

The pressing device 4 will not be described in detail, but it will be noted that it includes a pivoting lever 3 carrying the embossing head 2, the aforementioned lever pivoting being actuated by a piston.

The embossing head 2 including several serrated marking rollers 6a, 6b, 6c, 6d, 6e, 6f assembled on a transverse axis is carried by two lateral walls that support the serrated rollers.

According to the preferred embodiment described by way of example, the embossing head includes a stacking, that is a succession of six serrated marking wheels 6a, 6b, 6c, 6d, 6e, 6f laid out side by side in an adjacent way on the pivot axis 7 and advantageously without space between each of them, that is between their respective adjacent sides.

In addition, the serrated rollers assembly 10 is disposed between the two sides or lateral walls 11a, 11b of the control assembly 12 which includes an operating pawl 13 and an actuation finger.

The control assembly 12 is disposed pivotally on the support for the serrated rollers 9 on the axle 7 being used as the axis of rotation of the serrated marking rollers.

Let us note that the operating pawl is urged during actuation towards the serrated rollers thanks to a torsion spring 15.

Each of the serrated rollers includes a system of angular indexing, that is to say by positioning it in rotation, constituted by a ball 16 urged by a compression spring 17 which is lodged in a corresponding bore in the rotation axle 7 which, in addition, is blocked in rotation.

Each of the balls 16 is intended to cooperate with a succession of pits or detents 19 formed in the bore of the corresponding serrated rollers.

Each of the serrated rollers includes along with its periphery a succession of markers in relief 20 which, in the mode of realization given by way of example, are the figures, 0, 1, 2, 3, 4, 5, 6, 7, 8, 9 distributed uniformly with the periphery. Between each marker of each serrated marking roller, is seen a hollow zone 21, advantageously flat, which advantageously includes a pit or detent thus allowing the manual rotation of the serrated rollers by inserting a pointed rod, thus allowing a manual indexing of each of said serrated marking rollers.

Each hollow zone 21 defines an abutment or edge 24 for engagement by the corresponding teeth of the operating pawl.

Let us note that the first serrated roller 6a includes in addition, on the external diametrical face 25 a succession of hollow profiles 26.

Let us also note that each of the serrated rollers includes a release 27 open towards the exterior.

The operating pawl 13 is one piece and includes at the extreme end the control arm 28 a part curved towards the serrated rollers a succession of staged teeth 29a, 29b, 29c, 29d, 29e, 29f the number of which corresponds to the number of serrated rollers, shown in our example as six teeth whose height decreases from the first tooth which is designed to cooperate with the first serrated roller to the last tooth which is designed to cooperate with the last serrated roller. It was understood that thanks to the teeth 29a, 29b, 29c, 29d, 29e, 29f that are at one end of actuation plate, engagement of the serrated marking rollers of any thickness is permitted, by action on the abutment 24.

We add that the first tooth 29a includes, in addition, a side projection destined to cooperate with the side hollow patterns 26. Thanks to the presence of the side projection 30 and its cooperation with the successive hollow lateral side patterns 26, the teeth assembly 29a, 29b, 29c, 29d, 29e, 29f, do not rub on the figures or markings 20 which avoids their premature wear. Indeed, the side projection 30 projects further than the ends of the teeth of the pawl 13.

It will be also noted that the control ensemble 12 is biased toward an inactive position (that is according to which the pawl is not in contact with the serrated rollers) by a tension spring 31.

In the position shown is FIG. 2, the pivoting lever 3 is in its low position, a position according to which the sheet to be marked was pinched between the succession of the serrated marking rollers and the anvil 5, in order that the line of figures is inscribed in the sheet by deformation.

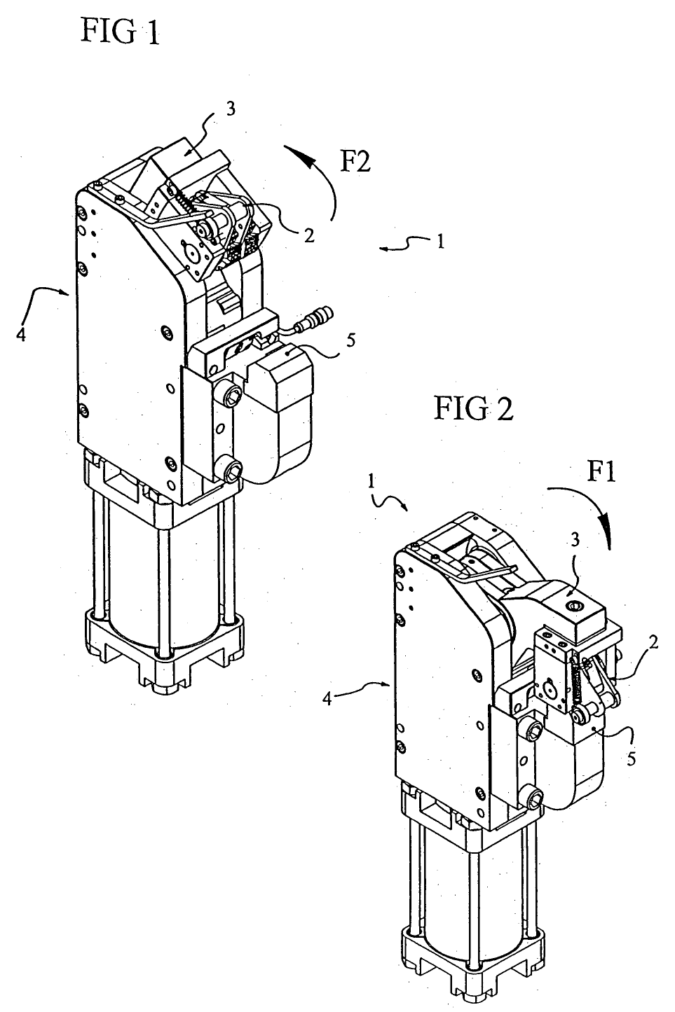

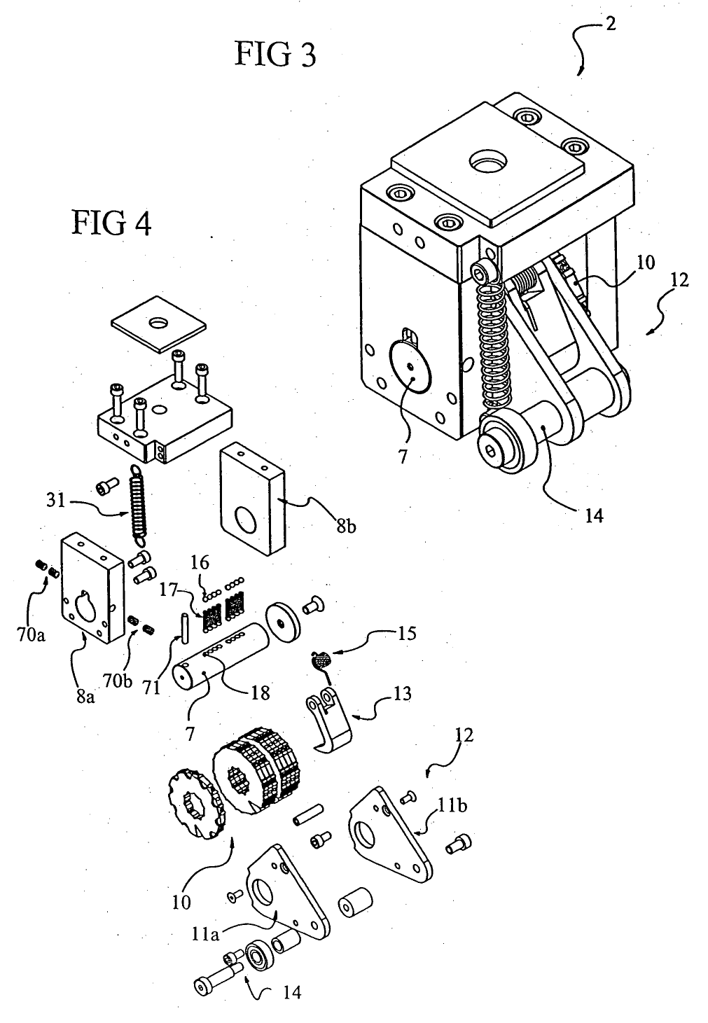

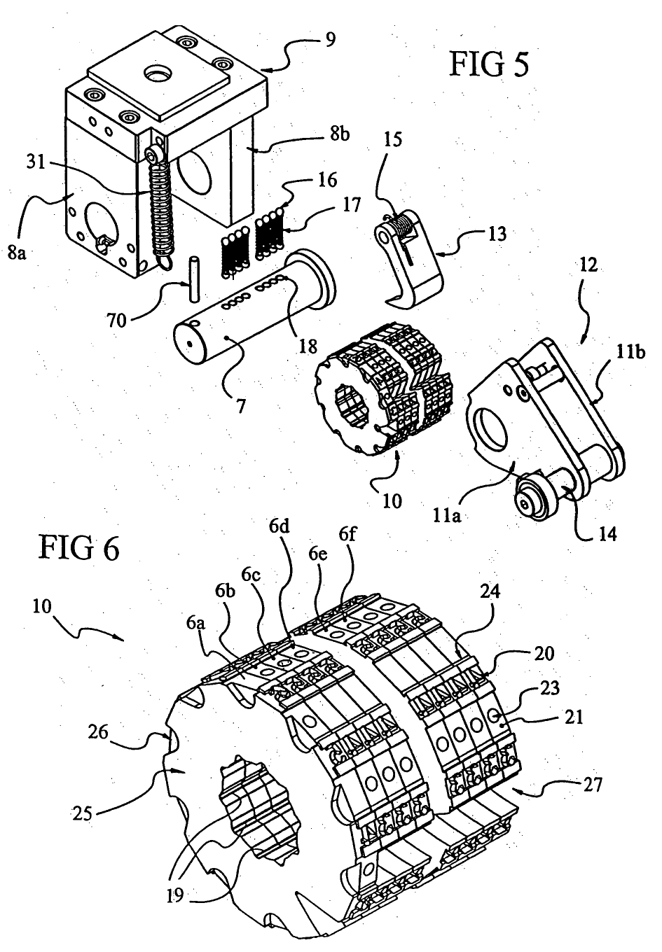

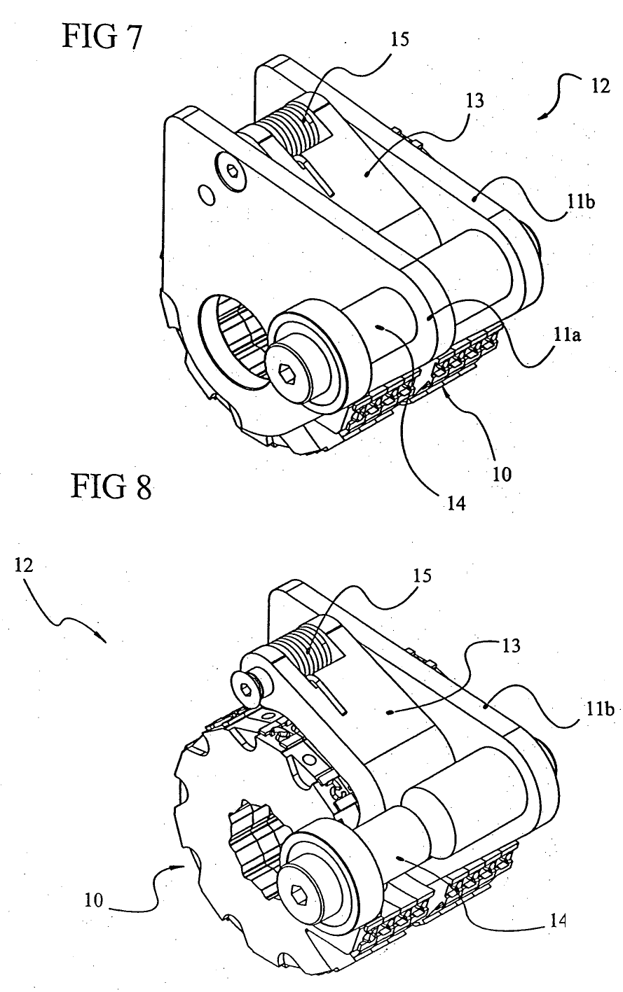

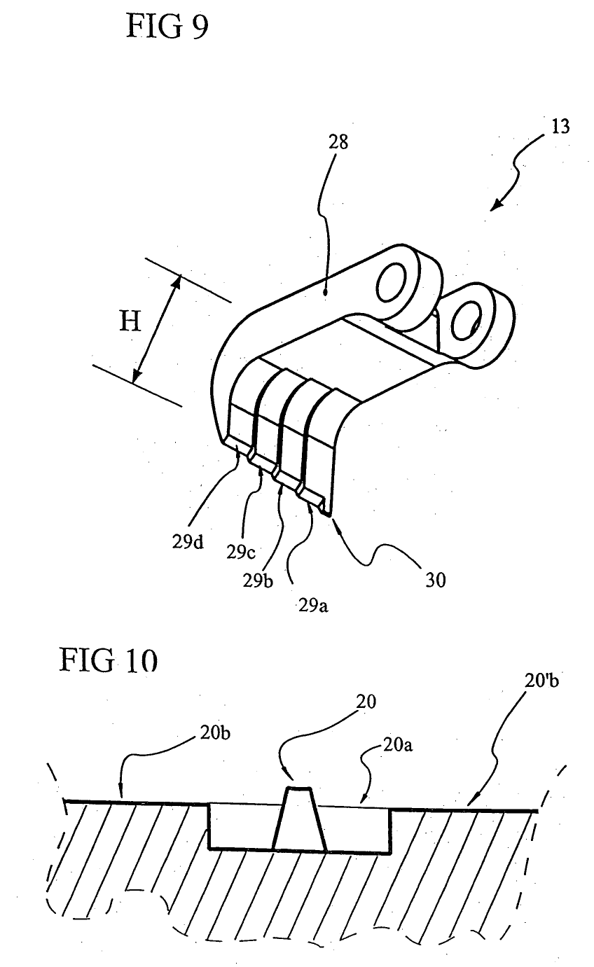

Once the sheet is marked, the pivoting lever 3 rotates towards the top according to arrow F2 to attain the position illustrated in FIG. 1. In the high position, the actuation finger 14 comes to impact against an abutment 32 which pushes the pivot arm towards the bottom of the control ensemble and the fingers 29 . . . into pivoting interaction with the serrated rollers in order to index the marking to the next higher number.

It will be added that the embossing head will include means of regulating the parallelism of markings about the sheet. To do this one of the lateral walls 8a includes two adjustable set screws 70a, 70b intended to cooperate with the adjusting vertical stem 71 interdependent of the axis of rotation 7 of the whole combination of serrated rollers. This allows it to vary the angular position of the stem 71 and thus to position the whole collection of serrated marking rollers in a correct initial angular position.

FIG. 10 is a detailed sectional view taken through the marking, on which it is remarked that the marking 20 is placed in a hollow recess 20a bordered by two lateral support sides 20b, 20′b.

As is known, the invention is not limited by the embodiments described and represented by the titled examples, but it may also include all the equivalent techniques and thus their combinations.

1. An embossing head for marking metal objects, such as sheet metal, with serial identifications, the head comprising:
a series of rotating serrated rollers mounted on a transverse axle next to each other without space between their adjacent respective sides; and
a one piece operating pawl.

2. The embossing head according to claim 1, further including:
the control assembly including the operating pawl and an actuation finger.

3. The embossing head according to claim 2, wherein the operating pawl includes:
an operating arm at one end, a part of the operating arm is curved toward the serrated rollers;
a succession of staged teeth which correspond in number to the number of serrated rollers, a height of the teeth decreases from a first tooth to a last tooth.

4. The embossing head according to claim 3, wherein the first tooth includes a lateral side projection which cooperates with recessed profiles on a face of the first serrated roller.

5. The embossing head according to claim 4, further including:
a plurality of ball and compression spring combinations each disposed in a corresponding bore in the serrated roller axle for releasably blocking the serrated rollers against rotation.

6. The embossing head according to claim 5, further including:
a tension spring which biases the control assembly to an inactive position in which the pawl is not in contact with the serrated rollers.

7. The embossing head according to claim 1, further including:
two lateral walls between which the serrated marking rollers are mounted on the axle.

8. An embossing device equipped with an embossing head according to claim 1, the embossing head being carried by a pivoting lever of a pressing device which presses the rollers against an anvil on which the sheet to be marked is disposed.

9. An embossing device for embossing serial numbers in sheet metal, the embossing device comprising:
an anvil which supports a sheet to be embossed with a serial number;
a pressing device which presses an embossing head against the metal sheet supported on the anvil to emboss the serial number, the embossing head including:
an axle,
a plurality of serrated rollers rotatably mounted on the axle, the serrated rollers including a series of numbers separated by engageable abutments, the rollers being mounted directly adjacent each other without an intervening space,
a one piece pawl including a series of staged teeth corresponding in number to a number of rollers, the teeth descending in height, the pawl being mounted such that the teeth engage an abutment of one or more of the rollers as the embossing head moves between embossing and retracted positions.
